(19) United States
(12) Patent Application Publication
(10) Pub. No.: US 2005/0113085 A1
(43) Pub. Date: May 26, 2005

(54) Method and apparatus for interfacing analog data devices to a cellular transceiver with analog modem capability

(76) Inventors: Daniel Giacopelli, Deer Park, NY (US); Frederick Engelking, Northport, NY (US)

Correspondence Address: MILTON S. GERSTEIN;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 10/979,270

(22) Filed: Nov. 2, 2004

Related U.S. Application Data
(60) Provisional application No. 60/523,889, filed on Nov. 20, 2003.

(51) Int. Cl. H04Q 7/20

(52) U.S. Cl. 455/426.2

(57) ABSTRACT

An interface device inserted in the telephone line between a data device and a fixed wireless terminal recognizes when the attached data device goes off-hook in order to send a string-command message and signal the fixed wireless terminal's cellular transceiver to change to the proper mode. The interface device is powered by the telephone line current provided by the fixed wireless terminal. The interface is pre-programmed to send a command dial-string, or other unique signal, that will cause the cellular transceiver of the FWT to process the data call correctly.

### CROSS REFERENCE TO RELATED APPLICATION

Priority of provisional application Ser. No. 60/523,889, filed on Nov. 20, 2003, is hereby claimed.

### BACKGROUND OF THE INVENTION

The present invention is directed to a method and apparatus for interfacing an analog data device, such as a fax, copying machine, and the like, to a fixed-wireless terminal (FWT). A conventional fixed wireless loop utilizes a fixed wireless terminal, such as that disclosed in commonly-owned U.S. Pat. Nos. 4,775,997 and 5,946,616, that consists of a cellular-interface unit that couples one or more standard POTS-type telephone sets, or the equivalents thereof, to a cellular, or cellular-like, transceiver for allowing the POTS-type telephones to be used in a radio network, such as a fixed cellular network.

Existing digital cellular systems are able to process voice and facsimile calls, as well as data transmission. However, these systems must know which one of these types of calls is to be processed. The above-described FWT with a digital cellular transceiver is normally connected to one or more POTS telephones in a mode that allows it to accept standard analog telephone signaling in order to connect a voice call. If an analog data device, such as a fax machine or modem, is connected instead of a POTS-type telephone, the vocoder of the digital cellular transceiver of the FWT will not correctly process the analog data tones sent to it. Instead, the FWT must be instructed to first set up a data or fax connection on the cellular system. This is accomplished by sending a string of DTMF audio tones that are recognized by the cellular transceiver. A plurality of POTS-type telephones, faxes, and the like, are typically connected to the FWT utilizing the installed landline premises wiring, as described in commonly-owned U.S. Pat. Nos. 5,715,296, 5,812,637, and 5,946,616, for example, by which just one FWT may service a plurality of landline-type of devices.

Most modem facsimile machines have the ability to dial a pre-programmed string of DTMF tones. This string may also be used to set up a cellular transceiver to access its fax capability. For instance, in a FWT, such as “PHONECELL” sold by Telular Corporation, of Vernon Hills, Ill., the instructions would be applied for a data device that does not have the ability to send a “setup” data string before dialing the directory number to which the call is to be sent. For example, to send a fax on a fax machine connected to the telephone jack, one must first dial the digit-string #*19*1 #, which is followed by the fax number to be called, after which the START on the fax machine is pressed. If the fax machine has the capability of storing telephone numbers for speed dialing, the “#*19*1 #” initial command-string may be programmed into the machine as a prefix to the telephone number to be dialed out. In some fax machines, it may be possible to store the command-string as a speed dial number and dial the remote fax machine telephone number manually. For transmission using data modems, the software that is used in its interface process may be used to provide the pre-programmed command string of DTMF tones.

The above-description is a workable solution for data devices that have the capability to store and send a pre-programmed command-string of digits. However, there is a large body of data devices that do not have this capability. As an example, these devices may include, but are not limited to: Office copiers that send periodic usage reports to the leasing agency, and home satellite television devices, such as “DIRECTV” or television recording device “TIVO” that send requests for programming to a control center that fulfills the request, etc. When these devices attached to the premises telephone line become active, there is no integral method to signal the fixed wireless terminal's cellular transceiver that the call must be in data format instead of voice. Without this notification, the fixed wireless terminal's digital cellular transceiver will not be able to handle the call correctly.

The string-command that is used to set up the cellular transceiver may generally take the format of “#*19*X#”. For fax-call set-up, the variable X is typically 1, as described above, while for data devices X is typically 2. This string-command may, of course, vary, and may utilize more variables to the string. For example, the string command may be “#*19*X*Y*Z#”, or the like, where Y and Z are extended setup-parameters, where, for example, Y may be the data rate and Z the number of stop-bits.

### SUMMARY OF THE INVENTION

It is the primary objective of the present invention to provide an interface between a fixed wireless terminal and a data device to be coupled to the FWT, so that the data to be sent out by the data device may be seamlessly and automatically transmitted over a radio network via the FWT.

The interface device or unit of the invention is inserted in the telephone line between the data device and the fixed wireless terminal, which interface device will recognize when the attached and coupled data device goes off-hook in order to send a command message and signal the fixed wireless terminal's cellular transceiver to change it to the proper mode. The interface device of the invention is powered by the telephone line current provided by the FWT. The interface device of the invention is pre-programmed to send a command dial-string, or other unique signal, that causes the cellular transceiver of the FWT to process the data call correctly for transmission thereby.

### BRIEF DESCRIPTION OF THE DRAWING

The invention will be more readily understood with reference to the accompanying drawings, wherein:

FIG. 1 is a block diagram showing a typical premises-installed fixed wireless terminal connected, via the premises wiring, to a plurality of premises-devices that are to be provided with the capability of making a call over the cellular, or cellular-like, network via the cellular, or cellular-like, transceiver of the FWT, and the data-interface unit of the present invention associated with conventional data devices for interfacing these data devices to the FWT's cellular transceiver;

FIG. 2 is a flow chart of the operation of the FWT of FIG. 1 when a call is to be made by one of the data devices having a data-interface unit associated therewith;

FIG. 3 is a block diagram showing the component-parts of the data-interface unit of FIG. 1;

FIG. 4 is a schematic of the switchable audio filter of the data-interface unit of FIG. 3;

FIG. 5 is a block diagram showing a modification of the configuration of FIG. 1, which communication between the data-interface units of the invention and the FWT is accomplished by means of over-the-air Bluetooth wireless connection; and

FIG. 6 is a block diagram showing the component-parts of the Bluetooth data-interface unit of FIG. 5.

### DETAILED DESCRIPTION OF THE INVENTION

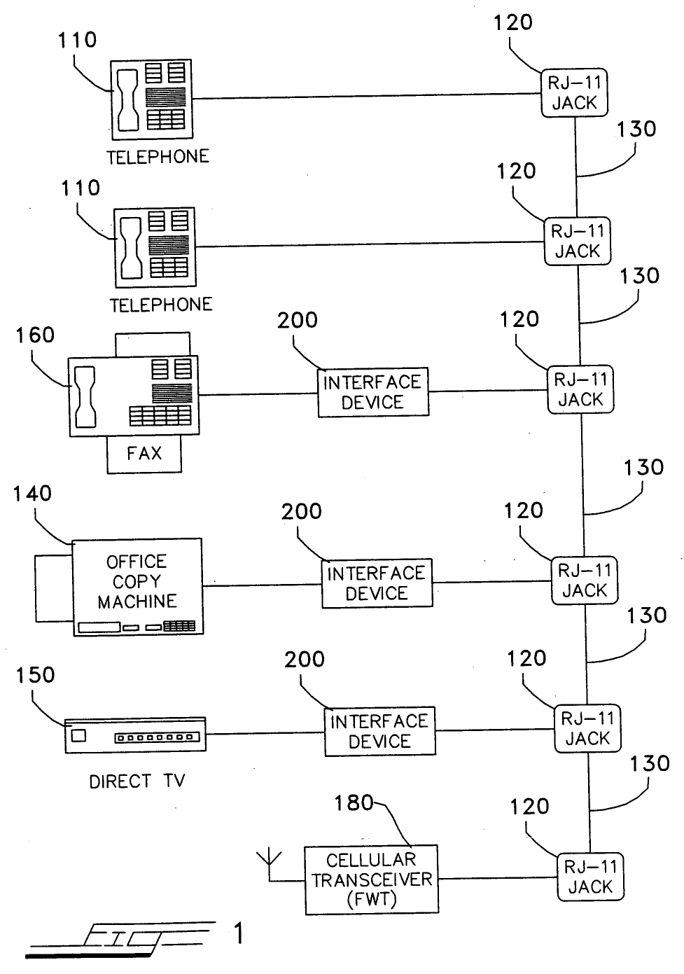

Referring now to the drawings in greater detail, in FIG. 1 there is shown a block diagram of a typical fixed wireless loop having a fixed wireless terminal (FWT) that utilizes the premises landline wiring for connecting a plurality of telephone equipment installed thereat for allowing each of them to make or receive a call via the switched cellular network, in the manner described in commonly-owned U.S. Pat. Nos. 5,715,296, 5,812,637, and 5,946,616. The premises has telephone wiring 130 with RJ-11 jacks 120 for interconnecting common POTS devices, such as POTS telephones 110, facsimile machines 160, and data devices, such as copy machine 140, satellite TV systems, such as “DIRECTV” box 150, or other data devices such as “TIVO”, cable TV box, data modem, and the like. Data-interface device 200 of the invention is provided for each data device, and couples each data device to the fixed wireless terminal's cellular transceiver 180 via the premises-wiring 130 and RJ-11 jacks 120. Each data interface device 200 is interposed between the respective data device and the RJ-11 jack 120 associated with that data device, as clearly seen in FIG. 1.

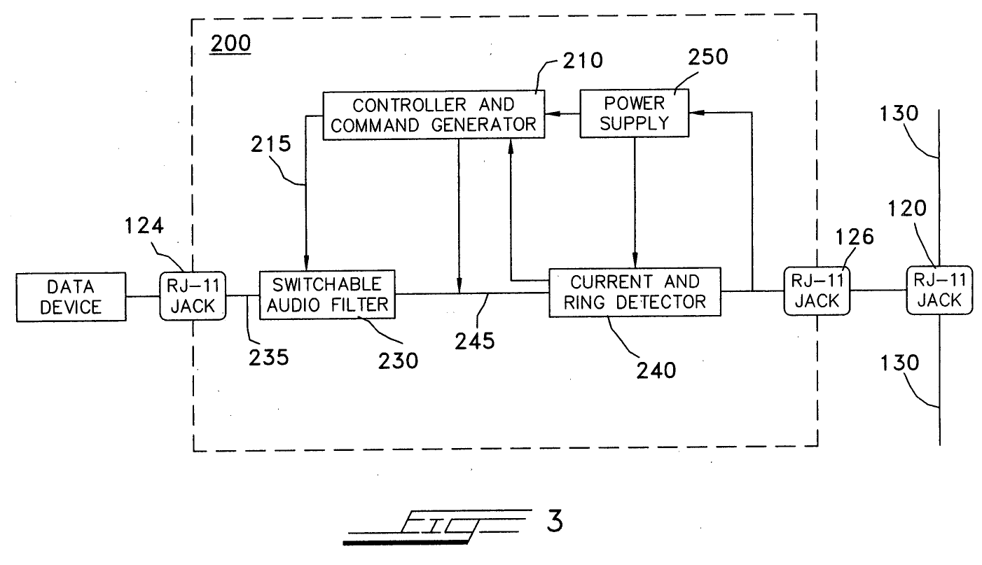

The data-interface unit 200 is contained in an enclosure or housing having at least two RJ-11 telephone jacks 124, 126, or the equivalents thereof, as shown in FIG. 3 and discussed hereinbelow, so as to insert the data-interface unit in the telephone line between the data device to be interfaced to the FWT 180 and the premises telephone wiring 130. The premises telephone wiring is connected to the FWT in the conventional manner, which FWT supplies all of the necessary voltages, currents and signaling to operate the POTS telephone devices that would normally come from the Public Switched Telephone Network (PSTN) central office (CO), as disclosed in commonly-owned U.S. Pat. Nos. 4,775,997 and 5,946,616.

The data-interface unit 200 has specific means for matching the command signal with the type of data device that it is coupling to the FWT 180. The data-interface unit or device 200 derives its operating power from the same fixed wireless terminal 180 that powers the premises telephone line. The data-interface unit 200 coupled to the fax 160 will generate the above-mentioned command-string signal #*19*1 #, which uniquely identifies the attached device as a facsimile machine. For the other data-interface units coupled to a copy machine or modem, a different command-string signal will be generated by the respective data-interface unit. It is to be noted that all data devices 200, save for facsimile machines, utilize the same pre-signalling command-string.

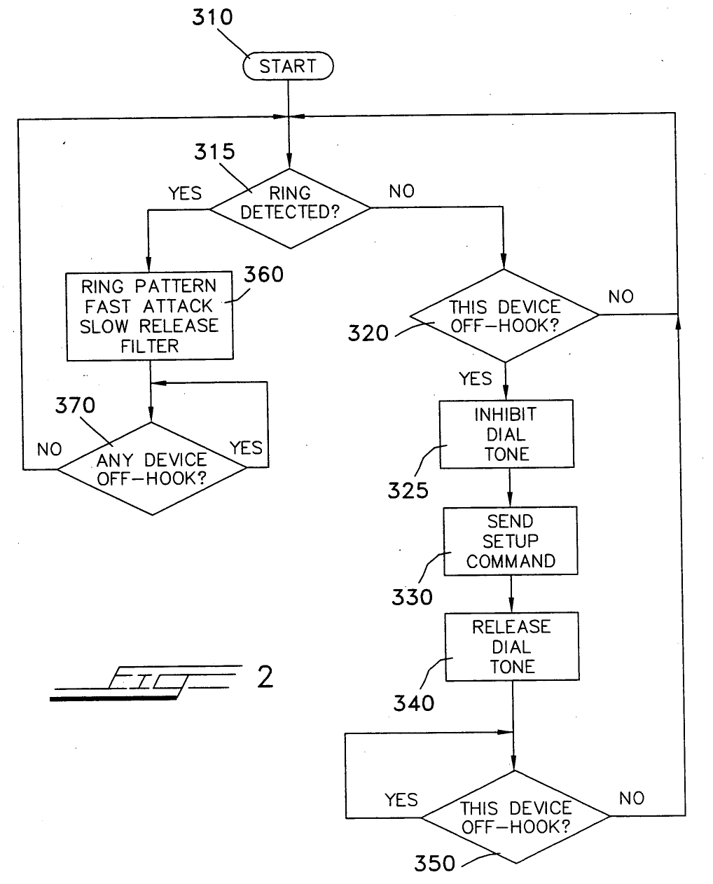

Referring to FIG. 2, there is shown a flow chart of the operation of the system of FIG. 1. In order to ensure that the interface device will not interfere with incoming calls, a ring detector is used to inhibit the activity of the interface when a call is received. When a ring is detected, the interface must not respond to any device going off hook. This is accomplished by detecting the ring (decision block 315), and waiting for the ring to be answered (block 360), which answering is achieved by means of a conventional ring-pattern, slow release, filter, where the pulse from the detector shows up at the output of the filter quickly (fast attack), but fades out slowly (slow release), thereby giving an output that stays up throughout the string of pulses. After detection of ring voltage, the software of the invention waits for the device to be hung up (decision block 370). The interface will then wait for another call, or respond to its own device going off hook.

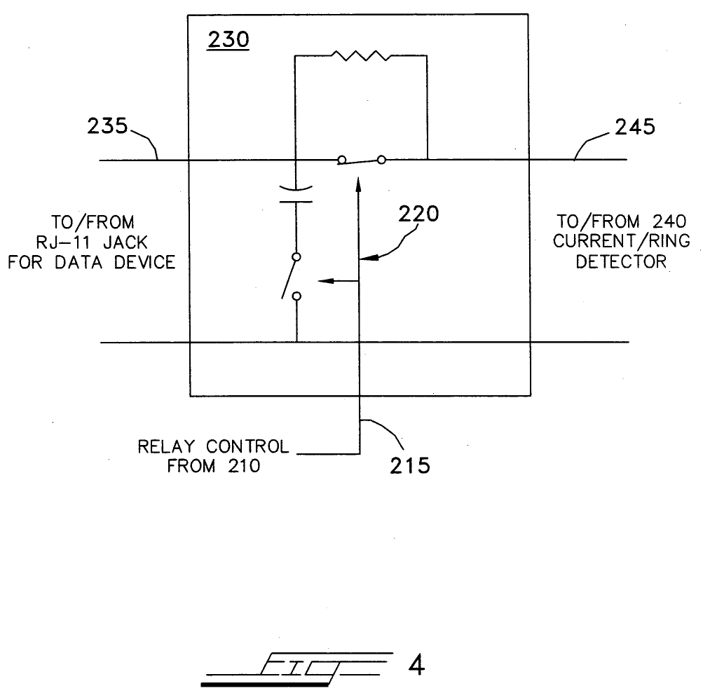

If no ring is detected, then a software module of the data-interface unit 200 determines when its respective, connected data device 140, 150, or 160 goes off-hook in order to send a message, which is accomplished by sensing or monitoring the line-current to the data device (decision block 320), as opposed to the monitoring of line voltage, which method, if used, would result in a false indication if any other POTS device on the line were to go off-hook. When the data-interface unit 200 senses that the data device has gone off-hook, the software module of the data-interface unit 200 temporarily inhibits passage of the dial tone from the FWT to the data device by generating a signal 215 that controls a relay 220 associated with a switchable audio filter, described in detail hereinbelow with reference to FIG. 4 (block 325), and sends a respective setup command to the FWT for its respective, connected data device, in order for the FWT to switch to a circuit-switched data mode (block 330). The respective setup command may be hardwired into the data-interface unit for low cost, or may be programmed in as, for example, by using a POTS telephone temporarily connected in place of the data device. The respective data device 140, 150, or 160, will wait for a dial tone before it initiates its message. After the respective command-string generated by the respective data-interface unit 200 has been sent to the FWT's cellular transceiver (block 330), the software module of the data-interface unit 200 then sends a signal 215 (FIG. 4) to cause the above-mentioned relay 220 of the switchable audio filter to allow the dial tone from the FWT to be delivered to the respective data device (block 340), in response to which the respective data device 140, 150, or 160, sends out its data-message call. After sending its data, the data device will disconnect, or go on-hook. The software module of the data-interface unit 200 decides when the data transmission has terminated by determining if there is a loss of line-current to the data device (decision block 350), and then returns to decision block 320 to prepare for the next call-event.

Referring to FIG. 3, there is shown the component parts of the data-interface 200 of the invention. Data-interface unit 200 uses audio tones, such as pulses, DTMF, or single tones, as the setup string-command to the FWT. Power supply 250 of the data-interface unit 200 is derived from the power supply of the FWT 180 through the premises wiring 130, and is a conventional or standard switching power supply that converts the varying DC voltage on the telephone line to the desired fixed DC voltage required. Conventional current and ring detector 240 senses when the respective, attached data device 140, 150 or 160 goes off-hook, and also indicates when ring voltage is present. The ring detector, includes a filter, as described above with reference to block 360 of FIG. 2, which filter is a conventional one, and prevents the interface from interfering with an incoming call, and converts the ring voltage pulses into a representation of the actual ringing time, which is much longer than the actual pulses. It is noted, that with regard to the flow chart of FIG. 2, the left branch thereof (blocks 360,370) is controlled by a voltage drop on the premise lines that represents any device going off hook on all of the connected premises wiring. Decision block 370 looks at the line voltage, which is typically 20 to 50 volts when idle, and 2 to 10 volts when any telephone or data device is off hook. The right branch of the software of FIG. 2 is controlled by the current detector, which only senses current into the device attached to it. Hence, it knows only when its own device is off hook.

A switchable audio-blocking filter 230 is provided to temporarily bock audio, primarily dial tone, from reaching the respective data device, but passes DC when the data device has gone off hook until the pre-command setup data string has been sent to the FWT. The switchable audio-blocking filter 230 is connected to the current and ring detector 240 via line 245 and to an RJ-11 jack 124 for the associated data device via line 235, and is temporarily activated to prevent dial tone from the FWT from being sent to the respective coupled device when the data device has gone off-hook and needs to sent its command string to set up the FWT's transceiver, and, as shown in FIG. 4, includes a RC filter having a 200 Ohm resistor and a 47 uF capacitor, and a normally open switch and a normally closed switch. The audio dial tone from the FWT is diminished to a level at which the attached data device will not respond when the filter is turned on. A software-controlled relay control 220 (FIG. 4) operates and activates the normally-deactivated filter 230 to open normally-closed switch and close normally-open switch to enable the audio-signal blocking in order to block the audio tones from the FWT while the setup command-string for the particular data device has been generated and sent to the cellular transceiver of the FWT. The relay switch 220 is controlled by the software program of the data-interface unit in a conventional manner, which software generates a signal 215 to this relay control of the switchable audio-blocking filter 230. It is, of course, to be understood that the equivalent of any of the above-described elements may be used instead, such as, for example, a solid state relay may be used instead of the relay switch 220.

Microcontroller 210 via memory stores the respective setup command for the particular data device connected thereto, that is used to signal the FWT, and generates the set-up command tones via a built-in, conventional tone DTMF generator to the telephone line for delivery to the FWT. The microcontroller, upon detecting off-hook of its associated data-device 140, 150, or 160, generates these set-up command tones, and, after delivery to the FWT, will deactivate the above-mentioned switch of FIG. 4 to allow for the bypassing of the audio-blocking filter 230, to allow the dial tone generated from the FWT to reach the data device, whereupon, the data device will dial out its call and transmit its data. Similarly, when the current and ring detector 240 senses ring voltage on the line, indicative of an incoming call via the FWT 180, the microcontroller and command generator 210 will ensure that the audio filter 230 remains disabled as long as the call is in progress, even after the associated device has gone off-hook, so that the device associated with that interface unit may be able to participate in the call, if so desired.

The states of the circuits, and, in particular, the switchable audio-blocking filter 230 above-described are as follows:
“Waiting for incoming call or for data device to go off-hook”: Relay deactivated, with filter out of circuit and signaling from FWT straight through telephone line;
“During incoming call”: Relay deactivated, with filter out of circuit with signaling from FWT straight through telephone line;
“Data device goes off hook”: Relay activated, filter in circuit, audio (dial tone) shunted to return telephone line via capacitor of filter, no effect on resistor side;
“Command string is sent”: Relay remains activated, filter in circuit, audio (dial tone) shunted to return line via capacitor of filter, no effect on resistor side so command from data device can propagate to FWT;
“Command string completed (fraction of second)”: Dial tone released to data device by relay being deactivated, filter out of circuit, and stays this way until data device goes off hook again.

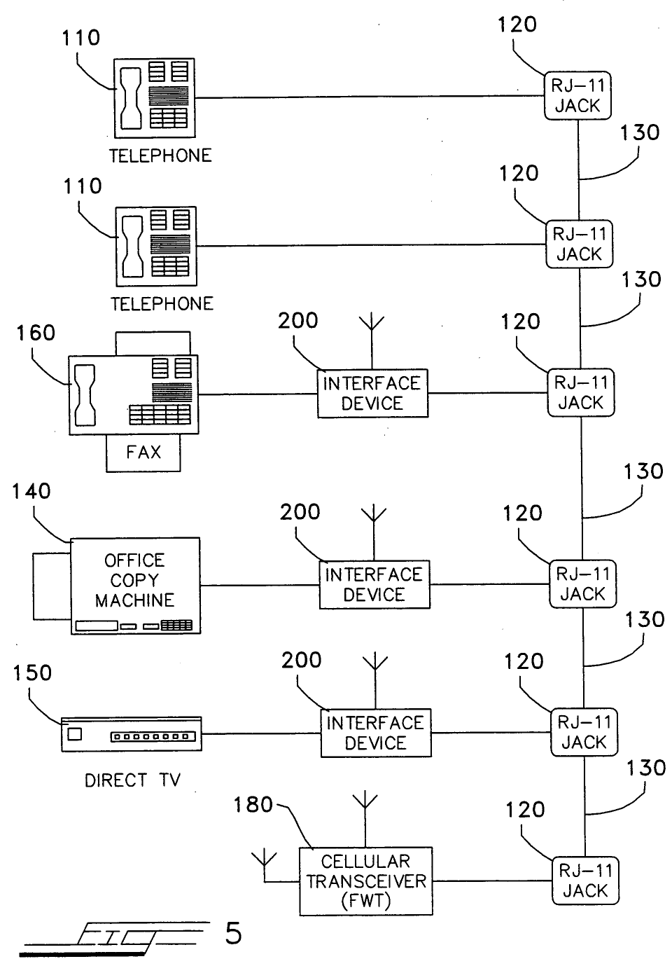

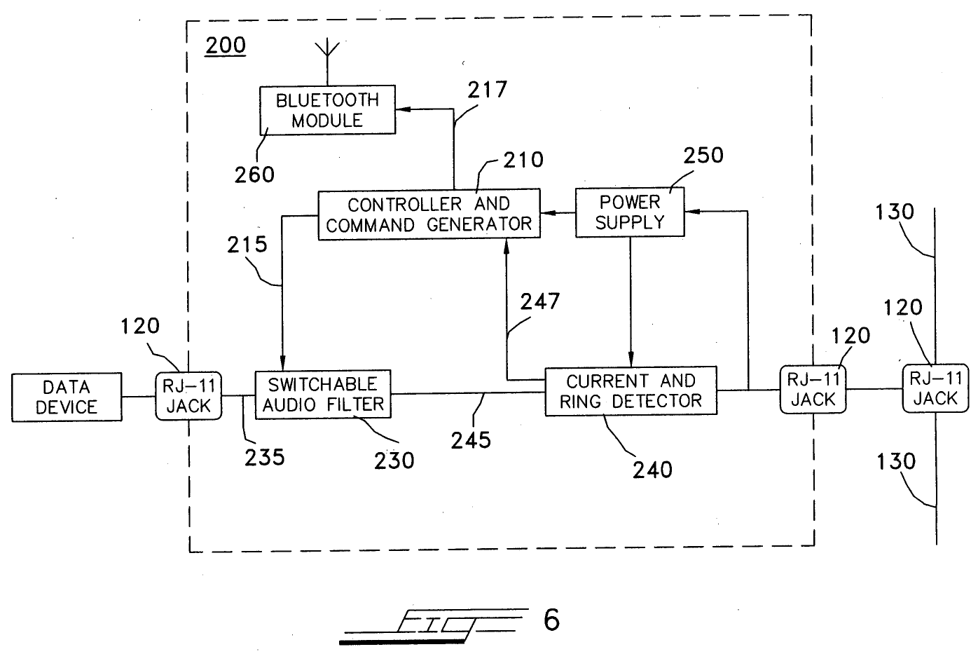

It is well within the scope and purview of the present invention to provide different means to alert the FWT 180 that a newly-activated POTS device must be treated as a data-call and not a voice call. For example, sending the setup command by means a RF signaling channel such as Bluetooth, Zigbee, UWB, ISM, or a wireless LAN connection, etc. may be employed. While the FWT must, of course, be aware of the signaling method, there is no requirement for any special modification to the standard data device. FIG. 5 shows such a modification using Bluetooth wireless, for example. The block diagram of FIG. 5 is similar to that of FIG. 1, with the exception that, instead of each data-interface unit 200 sending its signaling via hardwire-connection 120 and 130, it does so using conventional Bluetooth-wireless connection between the FWT and the data devices. The data-interface unit 200 according to this embodiment, as seen in FIG. 6, is the same as that shown in FIG. 3, with the exception of the Bluetooth-wireless transceiver module 260 that interfaces the microcontroller 210 to the FWT similarly equipped with a Bluetooth-wireless transceiver for communicating with the Bluetooth-wireless transceiver module 260.

While specific embodiments of the invention have been shown and described, it is to be understood that numerous changes and modifications may be made therein without departing from the scope and spirit of the invention.

1. In a fixed wireless loop comprising a fixed wireless terminal having a radio transceiver for communicating via a radio network, premises wiring to which said fixed wireless terminal is connected, and at least one telephone communication instrument also connected to said premises wiring, whereby said at least one telephone communication instrument is coupled to said fixed wireless terminal via said premises wiring, said at least one telephone communication instrument comprising at least one data communication device, such as a facsimile machine, copy machine, satellite TV system, and the like, which utilizes said transceiver of said fixed wireless terminal for sending data, the improvement comprising:
At least one interface means coupled between said at least one data communication device and said fixed wireless terminal for coupling said at least one data communication device to said fixed wireless terminal;
said at least one interface means comprising means for automatically generating a pre-signalling command-string to said fixed wireless terminal for establishing said transceiver of said fixed wireless terminal in its data-signalling mode when said at least one data communication device is ready to transmit data.

2. The fixed wireless loop according to claim 1, wherein said at least one interface means comprises a first interconnecting means for connection to said at least one data communication device, and a second interconnecting means for connection to said premises wiring.

3. The fixed wireless loop according to claim 2, wherein each of said first and said interconnecting means comprises a telephone jack.

4. The fixed wireless loop according to claim 1, comprising a plurality of telephone communication instruments connected to said fixed wireless terminal by said premises wiring, at least one of said plurality of telephone communication instruments consisting of a POTS telephone instrument, said at least one data communications device being at least one from the group consisting of a: facsimile machine, copy machine, satellite TV system, cable box, and data modem.

5. The fixed wireless loop according to claim 1, wherein said at least one interface means comprises blocking means for temporarily blocking audio signalling from said fixed wireless terminal to said at least one data communication device after said data communication device has been activated to transmit a data message call via said transceiver; and means for releasing said blocking means from blocking said telephone signaling from said fixed wireless terminal in order to allow said telephone signaling to be delivered to said at least one data communication device; said means for automatically generating a pre-signalling command-string to said fixed wireless terminal sending said pre-signalling command-string to said fixed wireless terminal before said blocking means is released from its blocking state, in order to set up said transceiver in its data-transmission mode before the data from said at least one data communication device is transmitted by said at least one data communication device.

6. The fixed wireless loop according to claim 5, wherein said at least one interface means comprises a microprocessor, memory means for said microprocessor, and software means stored in said memory means; said software means comprising means for controlling said releasing means for controlling said blocking means in order to prevent telephone signaling from said fixed wireless terminal reaching said at least one data communication device, and for allowing said telephone signaling to be directed to said at least one data communication device after said means for automatically generating a pre-signalling command-string to said fixed wireless terminal has sent said pre-signalling command-string.

7. The fixed wireless loop according to claim 6, wherein said fixed wireless terminal comprises a power source; said at least one interface means comprising power conversion means, said power conversion means being operatively coupled to the power source of said fixed wireless terminal for powering said at least one interface means; said releasing means comprises relay means, and said blocking means comprises audio filter means.

8. The fixed wireless loop according to claim 1, wherein said fixed wireless terminal comprises a power source; said at least one interface means comprises power conversion means, said power conversion means being operatively coupled to the power source of said fixed wireless terminal for powering said at least one data communication device from said fixed wireless terminal.

9. The fixed wireless loop according to claim 1, wherein said means for automatically generating a pre-signalling command-string to said fixed wireless terminal for establishing said transceiver of said fixed wireless terminal in its data-signalling mode comprises audio-tone generating means, and wireless transmission means for wirelessly transmitting said pre-signalling command-string to the fixed wireless terminal.

10. The fixed wireless loop according to claim 1, wherein said at least one interface means comprises current detection means for detecting the off-hook status of said at least one data communication device, and ring detection means for detecting ring voltage of an incoming call.

11. The fixed wireless loop according to claim 1, wherein said at least one interface means comprises a microprocessor, memory means for said microprocessor, software means stored in said memory means; and means for temporarily blocking audio telephone signalling from said fixed wireless terminal to said at least one data communication device; said software means comprising controlling means for controlling said means for blocking, said controlling means allowing said audio telephone signaling to be directed to said at least one data communication device after said means for automatically generating a pre-signalling command-string to said fixed wireless terminal has sent said pre-signalling command-string; said controlling means of said software means also controlling said blocking means for preventing said blocking means from temporarily blocking audio signalling from said fixed wireless terminal when said ring detection means detects ring voltage, whereby said at least data communication device may answer an incoming call.

12. The fixed wireless loop according to claim 5, wherein said means for blocking comprises a switchable audio-blocking filter, said switchable audio-blocking filter allowing passage of DC to said at least one data communication device when said at least one data communication device goes off-hook.

13. The fixed wireless loop according to claim 12 wherein said at least one interface means comprises current-detector means for detecting said passage of said DC to said at least one data communication device when said at least one data communication device goes off hook.

14. An interface device for use between a data communication device and a fixed wireless terminal having a radio transceiver for communicating via a radio network, whereby a data communication device may be coupled to the fixed wireless terminal, so that the which data communication device may utilize the transceiver of the fixed wireless terminal for sending data, comprising:
First coupling means for coupling to a data communication device, and second coupling means for coupling to a fixed wireless terminal for coupling a data communication device to the fixed wireless terminal for transmitting data by means of a radio transceiver;
sensing means for sensing the status of a data communication device when a data communication device is coupled to said first coupling means;
means for automatically generating a pre-signalling command-string for transmission to a fixed wireless terminal via said second coupling means for automatically establishing the radio transceiver of the fixed wireless terminal in a data-signalling mode when said sensing means detects a data communication device is ready to transmit data;
blocking means for temporarily blocking audio signalling from a fixed wireless terminal to a data communication device when said sensing means has detected that a data communication device has been activated to transmit a data message call; and
means for disabling said blocking means from blocking telephone signaling in order to allow audio signaling to be delivered to a data communication device coupled to said first coupling means after said means for automatically generating a pre-signalling command-string has generated said pre-signalling command string.

15. The interface device for use between a data communication device and a fixed wireless terminal according to claim 14, wherein said second coupling means comprises landline premises wiring; and further comprising power conversion means coupled to a power source of a fixed wireless terminal via said landline premises wiring for powering a data communication device coupled to said first coupling means.

16. The interface device for use between a data communication device and a fixed wireless terminal according to claim 14, wherein said means for automatically generating a pre-signalling command-string comprises audio-tone generating means, and wireless transmission means for wirelessly transmitting said pre-signalling command-string to the fixed wireless terminal;
said sensing means comprising current-detector means for detecting the off-hook status a data communication device coupled to said first coupling means.

17. A method of connecting a data communication device to a fixed wireless terminal having a radio transceiver, the data communication device capable of transmitting data over a radio network via a radio transceiver, comprising:
(a) coupling at least one data communication device to a fixed wireless terminal for transmitting data via the transceiver of the fixed wireless terminal;
(b) after the at least one data communication device has gone off-hook, automatically generating and sending a pre-signalling command-string to the fixed wireless terminal for establishing the transceiver of the fixed wireless terminal in its data-signalling mode;
(c) blocking audio signalling to the at least one data communication device from the fixed wireless terminal during said step (b);
(d) after said step (b) has been completed, allowing said audio signalling from the fixed wireless terminal to the at least one data communication device.

18. The method of connecting a data communication device to a fixed wireless terminal according to claim 17, wherein said step (a) comprises interconnecting at least one interface device between the at least one data communications device and the fixed wireless terminal; said step of interconnecting comprising using landline premises wiring; and, before said step (b), sensing the off-hook status of the at least one data communication device.

19. The method of connecting a data communication device to a fixed wireless terminal according to claim 18, wherein said step (a) comprises powering the at least one interface device from the power supply of the fixed wireless terminal; said step of interconnecting allowing dial tone from the fixed wireless terminal to pass to the at least one data communication device when the at least one data communication device has gone off-hook for transmitting data; said step (d) allowing passage of said off-hook current.

20. The method of connecting a data communication device to a fixed wireless terminal according to claim 17, wherein said step (a) comprises coupling a plurality of data communication devices to the fixed wireless terminal using the landline premises wiring; said step of interconnecting comprising interconnecting a plurality of interface devices between said plurality of data communication devices and said fixed wireless terminal, one interface device for one data communication device; and further comprising:
(e) detecting ring voltage from the fixed wireless terminal indicating the presence of an incoming call;
(f) after said step (e), allowing audio signalling from the fixed wireless terminal to the at least one data communication device after the at least one data communication device has gone off-hook, in order to allow the at least one data communication device to answer the incoming call.
